(19) United States
(12) Patent Application Publication
(10) Pub. No.: US 2018/0178462 A1
(43) Pub. Date: Jun. 28, 2018

(54) 360 COOLING DEVICE FOR 3D PRINTER

(71) Applicant: Robert Bosch Tool Corporation, Broadview, IL (US)

(72) Inventors: Daniel J. Blythe, Palatine, IL (US); Chris Dvorak, Chicago, IL (US); Eli Charles Share, Northfield, IL (US); Jon Michael J. Zasiebida, Bartlett, IL (US)

(21) Appl. No.: 15/389,045

(22) Filed: Dec. 22, 2016

(51) Int. Cl. B29C 67/00; B33Y 30/00; B33Y 40/00

(52) U.S. Cl. CPC B29C 67/0085; B29C 67/0055; B29K 2105/0067; B33Y 40/00; B33Y 30/00

(57) ABSTRACT

A cooling device for an extruder of a three-dimensional (3D) printer includes a cooling fan, a supply duct, and a cooling duct. The cooling fan generates a fluid stream which is directed to the cooling duct through the supply duct. The cooling duct has an outlet portion that is ring shaped. The outlet portion has an inner wall and an outer wall, the inner wall having a plurality of outlet holes which evenly distribute the fluid stream in a 360-degree pattern around a print nozzle of the extruder to cool the print nozzle, deposited resin, and/or a print surface.

### FIELD OF THE INVENTION

The present invention relates to 3D or additive printing or manufacturing, and more specifically to a cooling device for an extruder of a fused filament fabrication system.

### BACKGROUND

3D printing, or additive manufacturing, is a process of making three dimensional solid objects based on blueprints provided by digital files. The synthesis of the desired 3D object is achieved by strategically generating successive layers of an additive material (i.e., print material) in a pattern on a platform of a 3D printer until the entire object is created. The construction of the 3D object is driven by digital files that provide the specifications that describe how to create the pattern of layers and the materials used to generate the object. The digital files specifying the design are provided by the user, and examples of the digital files read by the 3D printer include G-code files, computer-aided design (“CAD”) files, STereoLithography (“STL”) CAD files, and other file types generally used in additive manufacturing processes.

The generation of the successive layers of the additive material can be performed, for example, according to any one of: (1) Vat Photopolymerisation, (2) Material Jetting, (3) Binder Jetting, (4) Direction Energy Deposition, (5) Powder Bed Fusion, (6) Sheet Lamination, and (7) Material Extrusion. Specific processes of Material Extrusion used to generate the successive layers can involve making sequential deposits using fused deposition modeling (“FDM”), fused filament fabrication (“FFF”), or Direct Ink Writing (“DIW”).

The materials used as the “ink” of the 3D printer to generate the 3D object can include, for example, any of: powder material, polymer material, thermoplastics, eutectic metals, edible materials, rubbers, modeling clay, plasticine, metal clay, ceramic materials, metal alloys, papers, composite materials composed of ceramics and metallic materials (“cermet”), metal matrix composites, ceramic matrix composites, photopolymers, plaster, stainless steel, aluminum, plastic film, and metal foil.

3D printers are generally protected from external influences by a build cage, and, within the build cage, the 3-D printer typically includes the following: (1) at least one extruder, (2) a guide rail system, (3) a build platform, (4) at least one filament spool, (5) and at least one motor for maneuvering the at least one extruder. In addition, the 3D printer includes a cooling system to regulate the temperature of the extruder.

Typically, during the operation of an FFF 3D printer, a plastic filament is unwound from a filament spool and supplied to an extruder. The extruder applies heat at a specific temperature to the filament, which melts the plastic filament to start material flow. Typically, the heat is applied at the extruder print nozzle, the extruder print nozzle having an outlet for the heated filament. Once the plastic filament has begun to flow, the motor for maneuvering the extruder uses the guide rail system to position (both horizontally and vertically) the extruder and extruder print nozzle relative to the build platform to apply a first layer of the 3D object to the build platform. Due the characteristics of the filament and the cooling system of the extruder, the filament cools shortly after it has been extruded. Once the first layer has been applied, the extruder is repositioned, and a second layer is applied on the surface of the first layer. This process is repeated until the 3D object is fully constructed.

### SUMMARY

Example embodiments of the present invention provide methods and systems to cool a print nozzle of an extruder of a 3D printer to improve the ability of the printed layers of a 3D object to adhere to respective surfaces (a base or previously printed layers) on which they are printed and to improve the overall print quality of the 3D object by cooling the deposited resin faster. Furthermore, the methods and systems of the present invention reduce warpage of the 3D that results from uneven cooling of the deposited resin and prevent distortion of the 3D due to movement of the print nozzle.

An example embodiment of the present invention relates to a cooling device for an extruder of a three-dimensional (3D) printer, the cooling device including: a cooling fan connected to the extruder, the cooling fan having an intake portion and output portion; a supply duct having a first opening and a second opening; and a cooling duct configured to direct a fluid stream generated by the cooling fan around a print nozzle of the extruder, thereby efficiently and effectively cooling the print nozzle of the extruder.

According to an example embodiment of the present invention, the cooling duct of the cooling device includes an intake portion and an output portion, where the output portion is ring shaped and encircles the print nozzle of the extruder.

According to an example embodiment of the present invention, the output portion of the cooling duct includes an outer surface and an inner surface, the inner surface having a plurality of outlet holes for evenly distributing the fluid stream in a 360-degree pattern around the print nozzle of the extruder.

According to an example embodiment, the cooling fan intakes a fluid in a horizontal direction at the intake portion of the cooling fan, the cooling fan outputs the fluid stream in a vertical direction at the output portion of the cooling fan, the first opening of the supply duct receives the fluid stream in the vertical direction from the output portion of the cooling fan, and the second opening of the supply duct outputs the fluid stream in a horizontal direction to the intake portion of the cooling duct.

According to an example embodiment, the outlet holes direct a portion of the fluid stream towards a printing surface, where the portion of the fluid stream directed towards the printing surface cools at least one of filament deposited by the print nozzle and the printing surface.

According to an example embodiment, the cooling fan is a centrifugal fan, and the supply duct is a 90 degree elbow duct.

Example embodiments of the present invention relate to a method of cooling a print nozzle of an extruder of a 3D printer. An example of cooling a print nozzle of an extruder of a 3D printer includes: receiving a fluid from an intake portion of a cooling fan; generating a fluid stream with the cooling fan; directing the fluid stream to a supply duct, the supply duct having a first opening and a second opening; directing the fluid stream from the supply duct to a cooling duct; and directing the fluid stream from the cooling duct around a print nozzle of the extruder.

These and other features, aspects, and advantages of the present invention are described in the following detailed description in connection with certain exemplary embodiments and in view of the accompanying drawings, throughout which like characters represent like parts. However, the detailed description and the appended drawings describe and illustrate only particular example embodiments of the invention and are therefore not to be considered limiting of its scope, for the invention may encompass other equally effective embodiments.

### BRIEF DESCRIPTION OF THE DRAWINGS

FIG. 1 is a perspective view of an example extruder assembly of a 3D printer, according to an example embodiment of the present invention.

FIG. 2 is a side view of the example extruder assembly of the 3D printer, according to an example embodiment of the present invention.

### DETAILED DESCRIPTION

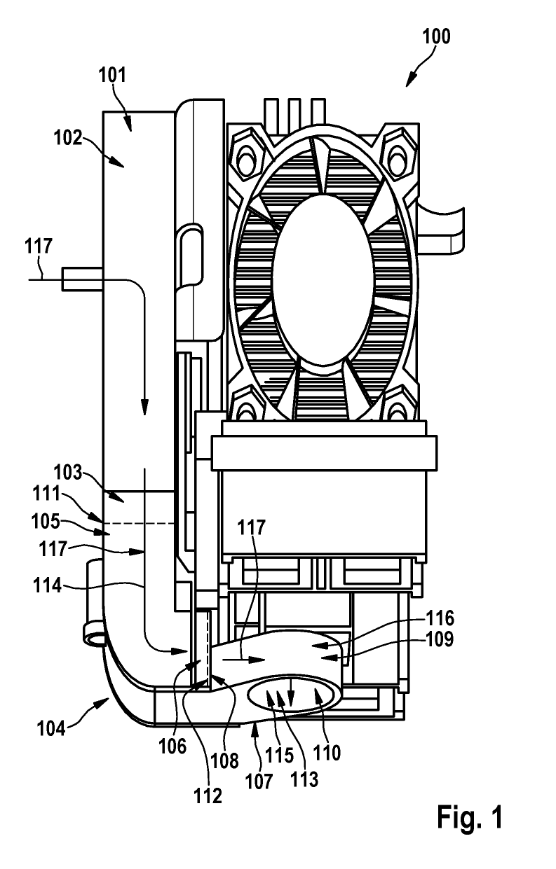

FIG. 1 is a perspective view of a cooling device for an extruder of a 3D printer, including cooling fan 101, supply duct 104, and cooling duct 107.

As shown in FIG. 1, the cooling device is configured to intake a fluid at intake portion 102 of cooling fan 101. Cooling fan 101 can be, for example, a centrifugal fan. Cooling fan 101 generates fluid stream 117 that flows in a vertical/radial direction toward output portion 103. Fluid stream 117 vertically enters first opening 105 of supply duct 104 at interface 111. Supply duct 104 can be, for example, a 90 degree elbow duct. Supply duct 104 directs fluid stream 117 through a 90-degree turn 114, which causes fluid stream 117 to horizontally exit supply duct 104 at second opening 106 of supply duct 104 at interface 112. Fluid stream 117 horizontally enters intake portion 108 of cooling duct 107 at interface 112. Cooling duct 107 horizontally directs fluid stream 117 towards output portion 109 of cooling duct 107. Output portion 109 of cooling duct 107 is ring shaped and encircles print nozzle 110. Output portion 109 has inner surface 115 and outer surface 116, and inner surface 115 has a plurality of outlet holes 113. Fluid stream 117 exits output portion 109 of cooling duct 107 through outlet holes 113 and cools print nozzle 110. In this manner, cooling device 101 distributes fluid stream 117 in a 360-degree pattern around print nozzle 110 of extruder 100. In an example embodiment, the supply duct 104 and the cooling duct 107 are a single integral component. In an example embodiment, the cooling fan 101 and supply duct 104 are formed as a single integral component. In an example embodiment, the cooling fan 101, supply duct 104, and cooling duct 107 are formed as a single integral component.

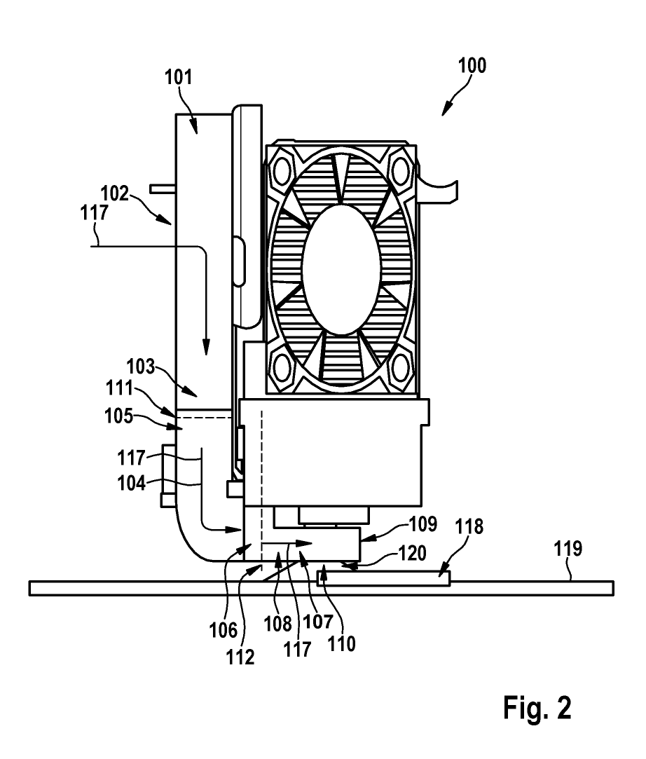

FIG. 2 is a side view corresponding to FIG. 1, according to an example embodiment of the present invention.

In addition to the features described with respect to FIG. 1, FIG. 2 depicts deposited filament 118 and print surface 119. As shown in FIG. 2, in addition to outlet holes 113 (not shown in FIG. 2) directing fluid stream 117 around print nozzle 110, outlet holes 113 direct portion 120 of fluid stream 117 towards deposited filament 118 and print surface 119.

An example embodiment of the present invention is directed to a method, e.g., of a hardware component or machine, of generating air flow in the manner described above.

The above description is intended to be illustrative, and not restrictive. Those skilled in the art can appreciate from the foregoing description that the present invention can be implemented in a variety of forms, and that the various embodiments can be implemented alone or in combination. Therefore, while the embodiments of the present invention have been described in connection with particular examples thereof, the true scope of the embodiments and/or methods of the present invention should not be so limited since other modifications will become apparent to the skilled practitioner upon a study of the drawings, specification, and following claims.

What is claimed is:

1. A three-dimensional (3D) printer assembly comprising:
an extruder; and
a cooling device that includes:
a cooling fan having an intake portion and an output portion; and
a supply duct arranged for receiving air from the cooling fan at the output portion of the cooling fan and directing the received air in a fluid stream towards a ring shaped region of the supply duct that encircles a print nozzle of the extruder, the ring shaped region including at least one opening through which the supply duct is configured to output the fluid stream circularly around the print nozzle.

2. The device of claim 1, wherein the at least one opening includes a plurality of outlet holes through the ring shaped region for evenly distributing the fluid stream in a 360-degree pattern around the print nozzle of the extruder.

3. The device of claim 2, wherein the ring shaped region includes an inner external wall through which the plurality of outlet holes extend and an outer external wall, the fluid stream flowing within the ring shaped region between the inner and outer external walls.

4. The device of claim 2, wherein the outlet holes are configure to direct a portion of the fluid stream towards a printing surface underlying the print nozzle for cooling at least one of filament deposited by the print nozzle and the printing surface.

5. The device of claim 1, wherein:
the cooling fan intakes air and directs it radially for entry into the supply duct in a first direction; and
the supply duct directs the air that has entered into the supply duct from the cooling fan in a second direction that is perpendicular to the first direction.

6. The device of claim 5, wherein the air enters into the cooling fan in a third direction that is perpendicular to the first direction and parallel to the second direction.

7. The device of claim 6, wherein the cooling fan is a centrifugal fan.

8. The device of claim 5, wherein the supply duct includes a 90 degree elbow region.

9. A method for cooling an extruder of a three-dimensional (3D) printer, the method comprising:
receiving, by a cooling fan, a fluid at an intake portion of the cooling fan;
generating a fluid stream with the cooling fan;
directing the fluid stream, by a supply duct, from the cooling fan towards and through an outlet by which the fluid steam exits the supply duct as an exit supply that encircles a print nozzle of the extruder.

10. The method of claim 9, wherein the supply duct includes a ring shaped output portion that encircles the print nozzle of the extruder.

11. The method of claim 10, wherein:
the ring shaped output portion of the cooling duct includes an inner external wall through which a plurality of outlet holes extend and an outer external wall;
the outlet holes are arranged in an evenly distributed 360-degree pattern around the print nozzle of the extruder; and
the fluid stream flows within the ring shaped output portion between the inner and outer external walls.

12. The method of claim 11, wherein the outlet holes direct a portion of the fluid stream towards a printing surface, and the portion of the fluid stream directed towards the printing surface cools at least one of filament deposited by the print nozzle and the printing surface.

13. The method of claim 9, wherein:
the cooling fan intakes air and directs it radially for entry into the supply duct in a first direction; and
the supply duct directs the air that has entered into the supply duct from the cooling fan in a second direction that is perpendicular to the first direction.

14. The method of claim 13, wherein the air enters into the cooling fan in a third direction that is perpendicular to the first direction and parallel to the second direction.

15. The method of claim 14, wherein the cooling fan is a centrifugal fan.

16. The method of claim 13, wherein the supply duct includes a 90 degree elbow region.
